(19) United States
(12) Patent Application Publication
(10) Pub. No.: US 2026/0022552 A1
(43) Pub. Date: Jan. 22, 2026

(54) MODULAR HYBRID BUILDING PANEL SYSTEMS

(71) Applicant: Mighty Buildings, Inc., Oakland, CA (US)

(72) Inventors: Yonah Naftaly, San Mateo, CA (US); Anna Ivanova, Santa Catarina (MX); Anna Khabarova, Reno, NV (US); John Going, Los Angeles, CA (US); Amichai Becker, Redwood City, CA (US); Dmitry Yakimovich, Santa Catalina (MX); Kevin Maldonado, Tracy, CA (US); Petr Ovchinnikov, Moscow (RU); Sergei Belorustsev, Moscow (RU); Egor Ilin, San Mateo, CA (US)

(21) Appl. No.: 18/777,833

(22) Filed: Jul. 19, 2024

(51) Int. Cl. E04B 1/14; B33Y 80/00; E04B 1/80

(52) U.S. Cl. CPC E04B 1/14; B33Y 80/00; E04B 1/80

(57) ABSTRACT

A modular hybrid building panel system configured to form an envelope for an entire building or a portion thereof can include a plurality of hybrid building panels, a plurality of panel connectors, and a plurality of anchoring components. Each hybrid building panel can include at least a structural insulated panel coupled with a customizable 3D-printed exterior cladding. The plurality of panel connectors can be coupled to the plurality of hybrid building panels and can be configured to couple the plurality of hybrid building panels to each other horizontally, vertically, or both. The plurality of anchoring components can be coupled to the plurality of hybrid building panels and can be configured to couple the plurality of hybrid building panels to one or more separate building components.

### TECHNICAL FIELD

The present disclosure relates generally to three-dimensional (“3D”) printing, and more particularly to the construction of building structures using 3D-printed components.

### BACKGROUND

Traditional residential and commercial building construction processes can be costly, complicated, and inefficient. The construction industry needs new construction systems that are less expensive, require less labor, and are faster to build. Structural insulated panels (“SIPs”) have been in use for some time as prefabricated building components. Advantages of SIPs include their high strength-to-weight ratios, high ultimate strengths, excellent insulation values, and labor-saving construction techniques. Early versions of SIPs can be found at, for example, U.S. Pat. Nos. 4,628,650 and 5,743,056. Although structurally sound and insulating, early SIPs such as these are only partially finished and require additional layers to serve as exterior cladding. Such added layers require additional labor and time to build on-site, however, which slows construction and adds costs.

Improvements in later SIPs include those found in U.S. Patent Publication No. 2011/0268916, which introduces a double-skin composite hybrid SIP including semi-flexible or rigid fiber-reinforced polymer laminate bonded to the SIP skin, as well as U.S. Patent Publication No. 2009/0293396, which discloses SIPs with faces enhanced with a structural paper to provide a ready to use finished surface. Both of these references claim that their SIPs can range from very small to very large sizes and perform better than traditional SIPs that do not contain finishing materials. Another example can be found at U.S. Pat. No. 8,844,243, which involves ways to connect SIPs at their sides, to ceiling or floor assemblies, and to foundations. Such connections do not allow these SIPs to contain an integral finish layer, however, since an on-site builder would need to penetrate the finish layer to fasten the panel, thus rendering the panel susceptible to air and water exposure which weakens the panel. The duplicated labor of fastening a panel on both sides and sealing at penetrations then increases on-site construction times and thus overall costs.

Although traditional ways of constructing buildings using SIPs have worked well in the past, improvements are always helpful. In particular, what is desired are combinations of SIPs and associated components that provide exterior cladding, finished surfaces, connection components, and other advantageous features within overall building construction systems and methods that are less expensive, faster to build with, and require less labor than traditional SIPs and associated components, arrangements, and systems.

### SUMMARY

It is an advantage of the present disclosure to provide SIP arrangements and systems with exterior cladding, finished surfaces, connection components, and other advantageous features that are less expensive, faster to build with, and require less labor than traditional SIPs and associated components, arrangements, and systems. The disclosed features, apparatuses, systems, and methods relate to improved SIPs and associated components suitable for use in residential and commercial building construction. In particular, the disclosed modular hybrid building panel systems include a variety of hybrid building panels having SIPs coupled to customizable 3D-printed exterior cladding, as well as panel connectors and anchoring components that can function together as an overall modular system to allow for easy installation to form an envelope of an entire building or portion thereof during building construction.

In various embodiments of the present disclosure, a modular hybrid building panel system configured to form an envelope for an entire building or a portion thereof can include a plurality of hybrid building panels, a plurality of panel connectors, and a plurality of anchoring components. Each of the plurality of hybrid building panels can include at least an SIP coupled with a customizable 3D-printed exterior cladding. The plurality of panel connectors can be coupled to the plurality of hybrid building panels and can be configured to couple the plurality of hybrid building panels to each other horizontally, vertically, or both. The plurality of anchoring components can be coupled to the plurality of hybrid building panels and can be configured to couple the plurality of hybrid building panels to one or more separate building components.

In various detailed embodiments, each of at least a portion of the plurality of hybrid building panels can include an SIP, a customizable 3D-printed exterior cladding, a subframe coupling the exterior cladding to the SIP, flashing tape configured to prevent water penetration, and one or more lifting features. Each SIP can have a rigid insulation layer between inner and outer stressed skins, as well as relief channels formed along the panel sides, top, and bottom. Each of the lifting features can be configured to facilitate transport of the hybrid building panel during hybrid building panel production, hybrid building panel installation to the entire building or a portion thereof, or both. At least a portion of the plurality of hybrid building panels can range from 2 to 6 feet wide, from 1 to 12 feet tall, and from 4 to 12 inches thick. At least a portion of the plurality of hybrid building panels can provide resistance to racking, axial and transverse loading, fireproofing, insulation, and exterior cladding capabilities to the entire building or a portion thereof. At least a portion of the plurality of hybrid building panels can be installed in a linear configuration or at an angle forming corners of the entire building or a portion thereof. At least a portion of the plurality of hybrid building panels can include integrated electrical chases. In some arrangements, at least one of the hybrid building panels can form a header panel located above a window, door, or other building opening. Such a header panel can be structurally reinforced with structural L-angles above and below the header panel.

In further detailed embodiments, at least a portion of the plurality of panel connectors can include one or more splines that can include composite lumber, lumber, steel, sheet goods, fiberglass structural shapes, or a thin SIP having a rigid insulation layer between two stressed skins. At least a portion of the plurality of anchoring components can include dimensional blocking formed of wood, steel, or composite lumber. At least a portion of the customizable 3D-printed exterior cladding can be fabricated via 3D printing layer extrusion from a weather-resistant, durable, polymer composite material. At least a portion of the customizable 3D-printed exterior cladding can include an outer surface that is planar and flat, that is configured to be modified to provide geometric flexibility, or both. At least a portion of the customizable 3D-printed exterior cladding can be affixed to an SIP outer stressed skin with one or more adhesives, screws, nails, bolts, rivets, staples, dowels, or any combination thereof. At least a portion of the customizable 3D-printed exterior cladding can be printed directly to and be securely adhered to an SIP outer stressed skin. Also, at least a portion of the customizable 3D-printed exterior cladding can include one or more finishing coatings.

In further embodiments of the present disclosure, various methods of assembling a modular hybrid building panel system to a building are provided. Pertinent process steps can include coupling a bottom dimensional blocking component to a foundation or a floor assembly of the building, placing a first hybrid building panel atop the bottom dimensional blocking component, coupling a bottom edge of the first hybrid building panel to the bottom dimensional blocking component, coupling a spline to a side edge of the first hybrid building panel, coupling the spline to a side edge of a second hybrid building panel, coupling a bottom edge of the second hybrid building panel to the bottom dimensional blocking component, placing a top dimensional blocking component along top edges of the first and second hybrid building panels, and coupling the top dimensional blocking component to the top edges of the first and second hybrid building panels. The first hybrid building panel can include a first SIP coupled with a first customizable 3D-printed exterior cladding. Coupling the bottom edge of the first hybrid building panel to the bottom dimensional blocking component can involve extending one or more fasteners through an interior surface of the first hybrid building panel, through the bottom dimensional blocking component, and into a first subframe of the first SIP. Coupling the spline to the side edge of the first hybrid building panel can involve extending one or more fasteners through the interior surface of the first hybrid building panel, through the spline, and into the first subframe of the first SIP. The second hybrid building panel can include a second SIP coupled with a second customizable 3D-printed exterior cladding. Coupling the spline to the side edge of the second hybrid building panel can involve extending one or more fasteners through an interior surface of the second hybrid building panel, through the spline, and into a second subframe of the second SIP. Coupling the bottom edge of the second hybrid building panel to the bottom dimensional blocking component can involve extending one or more fasteners through the interior surface of the second hybrid building panel, through the bottom dimensional blocking component, and into the second subframe of the second SIP. Coupling the top dimensional blocking component to the top edges of the first and second hybrid building panels can involve extending multiple fasteners through the first and second interior surfaces of the first and second hybrid building panels, through the top dimensional blocking component, and into the first and second subframes. The top dimensional blocking component can then function as a ledger for the first and second hybrid building panels.

In various detailed embodiments, additional process steps can include positioning the first hybrid building panel above the bottom dimensional blocking component, applying structural sealant to a bottom relief channel along the bottom edge of the first hybrid building panel, applying structural sealant to a side relief channel along the side edge of the first hybrid building panel, inserting the spline into a side relief channel along the side edge of the first hybrid building panel, applying structural sealant to a bottom relief channel along the bottom edge and a side relief channel along the side edge of a second hybrid building panel, and applying a joint seal at the top edges, side edges, bottom edges, and exterior surfaces of both of the first and second hybrid building panels.

In further embodiments of the present disclosure, various methods of prefabricating a hybrid building panel are provided. Pertinent process steps can include selecting a first SIP that includes a rigid insulation layer between inner and outer stressed skins, removing portions of the rigid insulation layer to form relief channels along top, bottom, and side edges of the first SIP, creating a subframe within the relief channels such that the subframe is affixed to an inner surface of the outer stressed skin, and coupling a 3D-printed exterior cladding to an exterior surface of the outer stretched skin using an adhesive, a plurality of mechanical fasteners, or both.

In various detailed embodiments, additional process steps can include cutting the first SIP to a specified size, trimming edges of the inner and outer stressed skins according to specific geometric configurations, forming one or more lifting features along a top portion of the subframe, wherein the one or more lifting features are configured to facilitate transport of the hybrid building panel during hybrid building panel production, installation to a building, or both, applying flashing tape across the top and bottom edges of the first SIP such that a portion of the flashing tape extends over the outer stressed skin and the subframe, machining the 3D-printed exterior cladding according to customized dimensions and configurations, and coating the 3D-printed exterior cladding to provide a uniform and protective finish. In the event that a panel thickness greater than four inches is desired for a given hybrid building panel, still further process steps can include selecting a second SIP having a second rigid insulation layer between second inner and outer stressed skins, removing portions of the second rigid insulation layer to form relief channels along top, bottom, and side edges of the second SIP, applying structural sealant to side relief channels along similar side edges of the first and second SIPs, inserting a spline into both of the side relief channels having structural sealant applied thereto, and coupling the first SIP and the second SIP to the spline by extending multiple fasteners through each SIP and into the spline. A single monolithic SIP can thus be formed having a thickness that is greater than four inches or a width that is greater than four feet. Further SIPs can similarly be added to create an even greater monolithic thickness and/or greater monolithic width where desired.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible features, structures, arrangements, systems, and methods for modular hybrid building panel systems. It will be understood that various aspects and features of the disclosed embodiments may be shown in exaggerated or enlarged form to facilitate understanding such that the drawings are not necessarily to scale. These drawings in no way limit any changes in form and detail that may be made to the disclosure by one skilled in the art without departing from the spirit and scope of the disclosure.

FIG. 1 illustrates in exploded perspective view an example modular hybrid building panel system according to one embodiment of the present disclosure.

FIG. 2A illustrates in front perspective view an example hybrid building panel according to one embodiment of the present disclosure.

FIG. 2B illustrates in exploded front perspective view the hybrid building panel of FIG. 2A according to one embodiment of the present disclosure.

FIG. 2C illustrates in top cross-section view the hybrid building panel of FIG. 2A according to one embodiment of the present disclosure.

FIG. 2D illustrates in side cross-section view the hybrid building panel of FIG. 2A according to one embodiment of the present disclosure.

FIG. 3A illustrates in front perspective view an example modular hybrid building panel system including a window assembly according to one embodiment of the present disclosure.

FIG. 3B illustrates in exploded front perspective view the modular hybrid building panel system of FIG. 3A according to one embodiment of the present disclosure.

FIG. 4A illustrates in front perspective view an example hybrid building panel for an inside building corner according to one embodiment of the present disclosure.

FIG. 4B illustrates in exploded front perspective view the hybrid building panel of FIG. 4A according to one embodiment of the present disclosure.

FIG. 4C illustrates in top cross-section view the hybrid building panel of FIG. 4A according to one embodiment of the present disclosure.

FIG. 5A illustrates in front perspective view an example hybrid building panel for an outside building corner according to one embodiment of the present disclosure.

FIG. 5B illustrates in exploded front perspective view the hybrid building panel of FIG. 5A according to one embodiment of the present disclosure.

FIG. 5C illustrates in top cross-section view the hybrid building panel of FIG. 5A according to one embodiment of the present disclosure.

FIG. 6A illustrates in front perspective view an example hybrid building panel with decorative cladding according to one embodiment of the present disclosure.

FIG. 6B illustrates in exploded front perspective view the hybrid building panel of FIG. 6A according to one embodiment of the present disclosure.

FIG. 6C illustrates in top cross-section view the hybrid building panel of FIG. 6A according to one embodiment of the present disclosure.

FIG. 6D illustrates in side cross-section view the hybrid building panel of FIG. 6A according to one embodiment of the present disclosure.

FIG. 7A illustrates in front perspective view an example expanded hybrid building panel according to one embodiment of the present disclosure.

FIG. 7B illustrates in rear perspective view the expanded hybrid building panel of FIG. 7A according to one embodiment of the present disclosure.

FIG. 7C illustrates in top cross-section view an example combining juncture of the expanded hybrid building panel of FIG. 7A according to one embodiment of the present disclosure.

FIG. 8A illustrates in top cross-section view an example side coupling juncture for side-by-side coupled hybrid building panels according to one embodiment of the present disclosure.

FIG. 8B illustrates in top cross-section view a front region of the side coupling juncture of FIG. 8A according to one embodiment of the present disclosure.

FIG. 8C illustrates in side cross-section view an example bottom coupling juncture for coupling a hybrid building panel to a building foundation according to one embodiment of the present disclosure.

FIG. 8D illustrates in top cross-section view an example vertical coupling juncture for multiple hybrid building panels according to one embodiment of the present disclosure.

FIG. 9 illustrates a flowchart of an example method of prefabricating a hybrid building panel according to one embodiment of the present disclosure.

FIG. 10 illustrates a flowchart of an example method of assembling a modular hybrid building panel system to a building according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure generally relates to structures, arrangements, systems, and methods relating to building construction. More specifically, the present disclosure introduces an integrated building envelope system that aims to compete with traditional construction by being less expensive, faster to build with, and requiring less labor and trades while offering superior performance and aesthetics. In particular, the disclosed modular hybrid building panel systems can allow for the ready formation and easy installation of components that can form an envelope of an entire building or portion thereof during building construction.

As noted above, traditional methods for constructing and finishing SIP exteriors often fall short of achieving a high degree of customization and complexity in design. In contrast, the utilization of 3D printing technology introduces pioneering methods for the development of building panels. Details regarding the use of 3D printing technology for construction materials can be found in, for example, U.S. Pat. No. 12,037,500 and U.S. patent application Ser. No. 18/198,810, both titled “COMPOSITION AND PRODUCTION METHOD FOR 3D PRINTING CONSTRUCTION MATERIAL,” and both of which are incorporated herein by reference in their entireties. The feasibility of using 3D printing to fabricate building panels that adhere to a broad spectrum of building codes and specifications can be found at, for example, U.S. patent application Ser. No. 18/634,320, titled “3D-PRINTED INTEGRATED BUILDING PANEL SYSTEMS,” which is also incorporated herein by reference in its entirety. Although helpful, this reference uses a steel frame for support and a furring wall for running systems and interior finish, with these specific items adding to the cost, on-site labor, and time to install these systems. In contrast, the various embodiments provided herein leverage many useful aspects of the foregoing reference by using less labor, time, and materials, marking a significant advancement in building technology. As such, the present disclosure simplifies the construction process while ensuring a high-quality, aesthetically rich exterior finish and strong structure.

The various systems disclosed herein can include a variety of hybrid building panels, panel connectors, and anchoring components that can function to form a building envelope or portion thereof during building construction. Such a building envelope can operate as a modular system, simplifying installation to shape the structure of the entire building during construction. Hybrid building panels can be significant components of such an integrated system, as they can combine SIPs with customizable 3D-printed cladding, thus serving as both load-bearing structural panels and exterior cladding. The present disclosure also introduces methods for prefabricating hybrid building panels and assembling the integrated building envelope system. This pioneering system represents a transformative leap in the construction industry. By adapting the SIP and marrying it with customizable 3D-printed exterior cladding, this can revolutionize traditional construction practices and set new standards for cost, speed, labor, performance, and aesthetic appeal of building solutions.

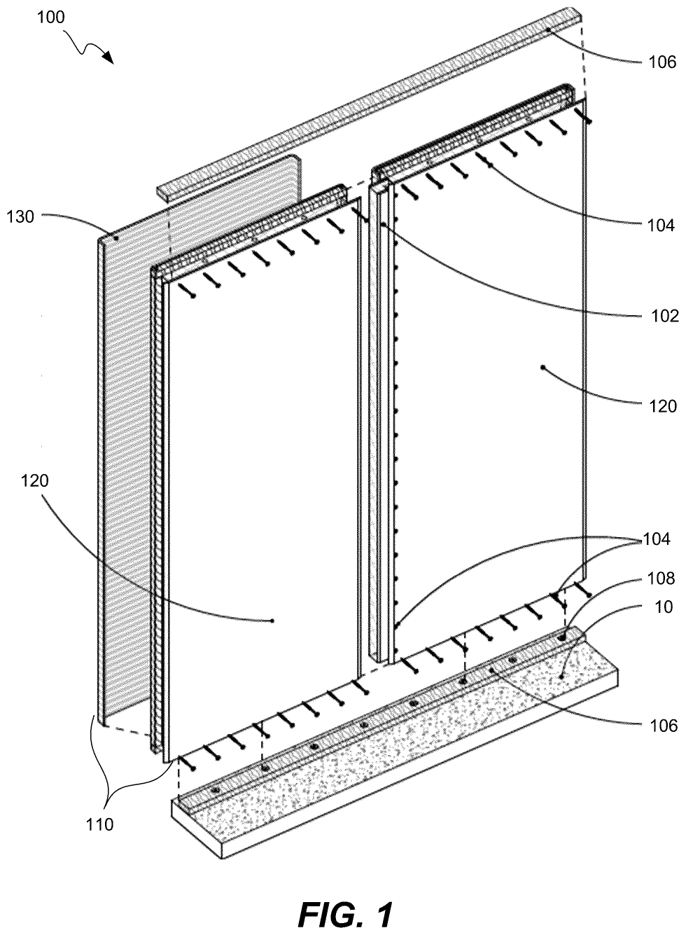

Referring first to FIG. 1, an example modular hybrid building panel system is illustrated in exploded perspective view. Modular hybrid building panel system 100 is shown from the perspective of an interior region of a building to which the system is installed. Modular hybrid building panel system 100 can generally be configured to form an envelope for an entire building or a portion thereof and can be readily and easily installed into its final form during building construction. As such, system 100 can also be called an integrated building envelope system. Modular hybrid building panel system 100 can include at least a plurality of hybrid building panels 110, a plurality of panel connectors 102, 104, and a plurality of anchoring components 106, 108, among other possible components.

Each hybrid building panel 110 can include at least an SIP 120 coupled with a customizable 3D-printed exterior cladding 130, which customizable cladding can be located at an exterior surface of the hybrid building panel and overall system 100. Each hybrid building panel 110 can serve as a modular building component designed to contribute to a portion of an entire building, such as a residential or commercial structure. Hybrid building panels 110 can conform to various construction industry structural support requirements, such as resistance to racking and axial and transverse loading, along with having fireproofing, insulation, and exterior cladding capabilities. Although only two hybrid building panels 110 are shown as being coupled side by side in FIG. 1, it will be understood that more hybrid building panels can be included in a given modular hybrid panel building system, and that these hybrid panels can be coupled to each other in horizontal and vertical directions by one or more types of panel connectors.

Panel connectors 102, 104 can be coupled to the hybrid building panels 110 and can be configured to couple the hybrid building panels to each other horizontally, vertically, or both. These panel connectors can include one or more splines 102 and one or more panel fasteners 104 that can be used to fasten an edge of a hybrid building panel 110 to a spline. Splines 102 can be formed from, for example, suitably sized and dimensioned composite lumber, lumber, steel, sheet goods, fiberglass structural shapes, or even a thin SIP having a rigid insulation layer between two stressed skins. Panel fasteners 104 can include, for example, suitably sized and dimensioned screws, nails, bolts, rivets, staples, dowels, or any other suitable fastener, as well as any combination thereof.

Anchoring components 106, 108 can be coupled to hybrid building panels 110 and can be configured to couple the hybrid building panels to one or more separate building components, such as a separate foundation or floor assembly 10 of a building. These anchoring components can include one or more dimensional blocking components 106 and one or more anchor fasteners 108 that can be used to fasten a dimensional blocking component 106 to the separate building component, such as foundation 10. Dimensional blocking components 106 can be formed of wood, steel, composite lumber, or any other suitable material. Anchor fasteners 108 can include, for example, suitably sized and dimensioned screws, nails, bolts, rivets, staples, dowels, or any other suitable fastener, as well as any combination thereof.

Dimensional blocking components 106 can extend across multiple hybrid building panels 110 such that the dimensional blocking effectively ties these panels together and acts as a ledge. This can effectively secure the building panels together and ensure that they form an integral part of the overall building architecture, which can include corner sections and other structural elements, as set forth in greater detail below. In addition to a building foundation 10, dimensional blocking components 106 can also be used to anchor hybrid building panels to other separate building components. For example, dimensional blocking component 106 located atop modular hybrid building panel system 100 shown in FIG. 1 can be used to anchor the system to a roof, ceiling, structural beam, or other separate building component. In some arrangements, dimensional blocking components 106 can also be used to couple hybrid building panels 110, such as in a vertical direction atop each other.

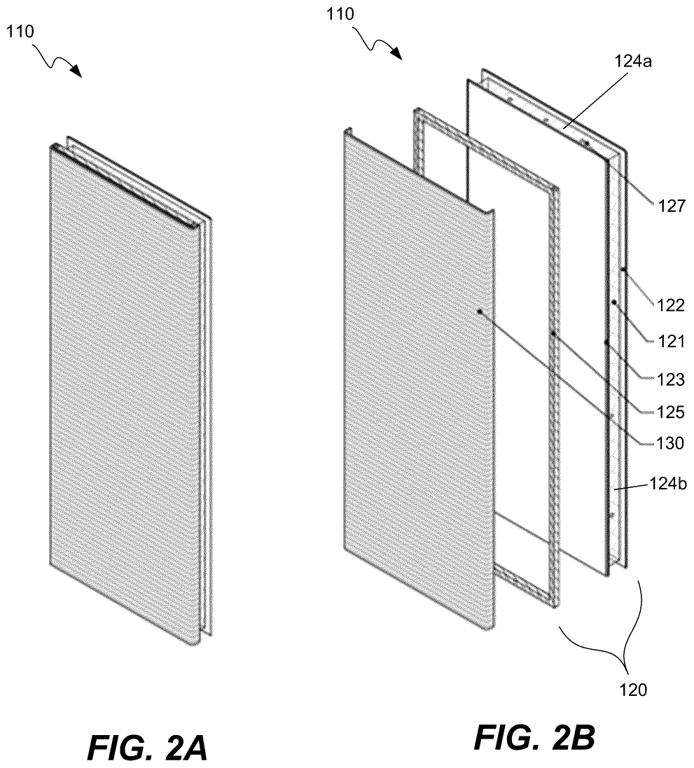

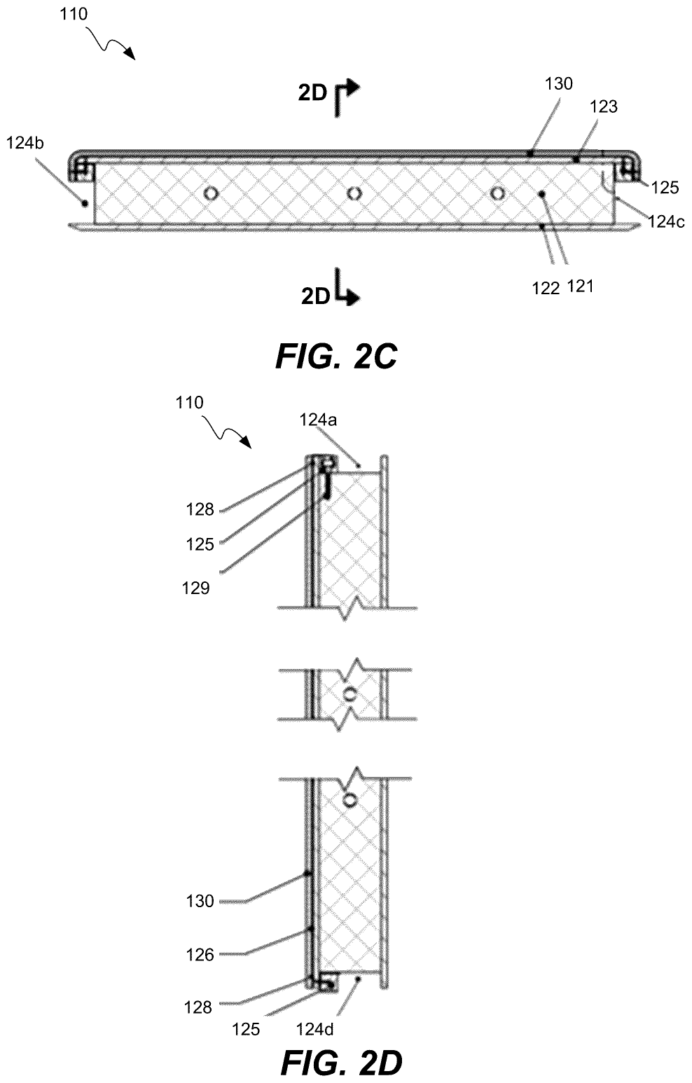

Continuing with FIGS. 2A-2D, an example hybrid building panel is depicted in front perspective, exploded front perspective, top cross-section, and side cross-section views respectively. The cross-section view of FIG. 2D is shown with respect to the “2D” markings in FIG. 2C, which view can be consistent for the middle portion of the panel between the side edges and relief channels. In some arrangements, hybrid building panel 110 can be considered a standard, straight, flat, full length building panel. Other shapes and sizes for similar hybrid building panels are set forth in greater detail below. While FIG. 2A shows hybrid building panel 110 as being fully assembled, FIG. 2B depicts the hybrid building panel in exploded view to show various pertinent components and features thereof. It will be appreciated that some or all of the building panels in an overall modular hybrid building system can be like hybrid building panel 110 or can be a suitably scaled version or extrapolated version thereof. Again, hybrid building panel 110 can include an SIP 120 (i.e., structural insulated panel) coupled with a customizable 3D-printed exterior cladding 130. SIP 120 can be a prefabricated building component having a rigid insulation layer 121 sandwiched between two structural facing components, such as inner stressed skin 122 and outer stressed skin 123. These stressed skins 122, 123 can be formed from any suitable material, such as, for example, oriented strand board, magnesium oxide board, cement board, and steel, among other possible materials.

SIP 120 can include relief channels 124 located along one or more edges of the panel, such as top relief channel 124a, right side relief channel 124b, left side relief channel 124c, and bottom relief channel 124d. These relief channels 124 can be formed into the rigid insulation layer 121 while allowing the stressed skins 122, 123 to extend around the channels, for example. Relief channels 124 can be used to receive panel connectors and/or anchoring components therein so as to couple hybrid building panel 110 at its top, side, and bottom edges to other hybrid building panels and/or separate building components, such as a building foundation.

SIP 120 can also include subframe 125, which can be formed from wood, composite lumber, or any other suitable construction material having sufficient structural strength. Subframe 125 can include four elements coupled together to form a shape that corresponds to the shape of SIP 120 along its relief channels 124, such as a rectangular shape, for example. As shown in the cross-section views of FIGS. 2C and 2D, subframe 125 can be positioned within each of relief channels 124a, 124b, 124c, 124d and alongside the inner surface of outer stressed skin 123. Subframe 125 can be bonded using a structural sealant at the interfaces where the subframe meets rigid insulation layer 121 of SIP 120 and also where the subframe meets the inner surface of outer stressed skin 123. Other coupling arrangements are also possible, as will be readily appreciated. Use of subframe 125 can enhance the overall structural integrity and stability of SIP 120 and the overall hybrid building panel 110 and can also provide a mechanism for additional coupling or support, such as for customizable 3D-printed exterior cladding 130.

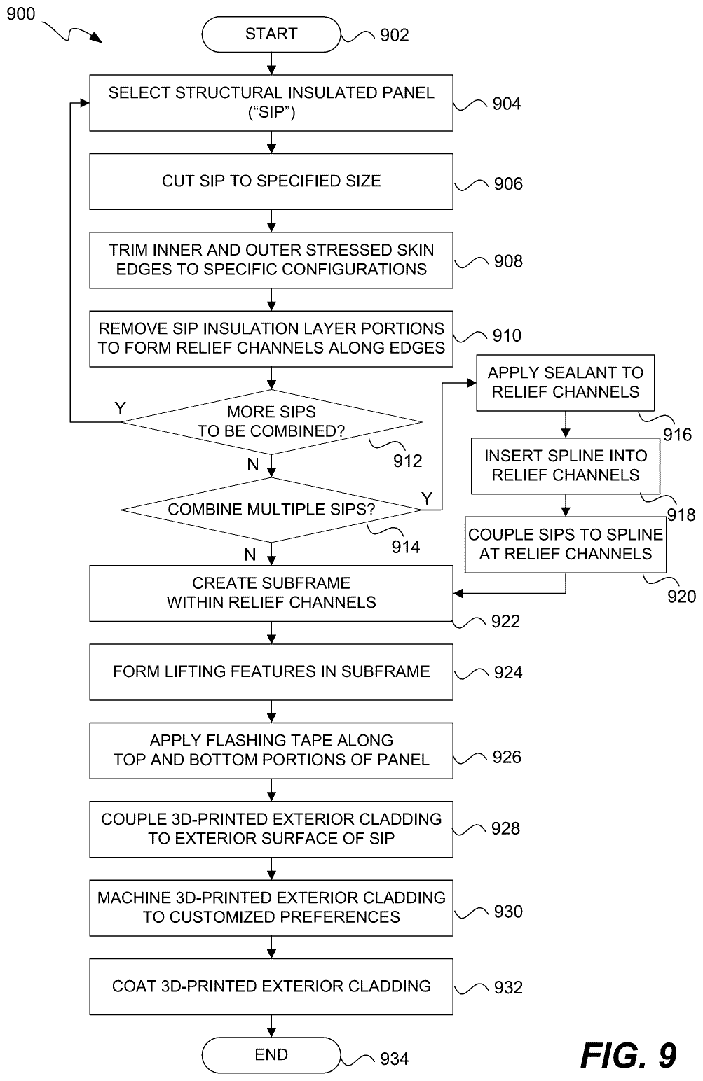

Again, hybrid building panel 110 can include a customizable 3D-printed exterior cladding 130, which can be manufactured with 3D printing using a weather-resistant, durable, polymer composite material. The cladding material can be produced by way of a 3D printing process involving layer-by-layer extrusion that imparts a distinctive layered texture to a final printed product. In some embodiments, customizable 3D-printed exterior cladding 130 can be coupled to outer stressed skin 123 of SIP 120, such as by way of an adhesive 126 or any other suitable coupling component or feature, as shown in FIG. 2D. Alternatively, or in addition, customizable 3D-printed exterior cladding 130 can be 3D printed directly onto outer stressed skin 123 and securely adhered or otherwise coupled to the facing of SIP 120. Customizable 3D-printed exterior cladding 130 can also be coupled to subframe 125 in some arrangements, and this can involve the use of one or more suitably sized and dimensioned screws, nails, bolts, rivets, staples, dowels, or any other suitable fastener, as well as any combination thereof. One specific nonlimiting example of such a coupling of cladding 130 to subframe 125 using fasteners can be found at FIG. 9A below. Such a dual coupling arrangement of customizable 3D-printed exterior cladding 130 to outer stressed skin 123 and also subframe 125 can ensure a robust and durable bond between the cladding and SIP 120.

In some embodiments, customizable 3D-printed exterior cladding 130 can be printed or configured such that the printed material can be customized after printing by way of one or more machining or other material removal or finishing processes. As such, all or at least a portion of customizable 3D-printed exterior cladding 130 can include an outer surface that is planar and flat, that is configured to be modified to provide geometric flexibility, or both. This can allow for a wide variety of customization of the 3D-printed material, either at a construction site or at a factory or other prefabrication or manufacturing facility. Customizable 3D-printed exterior cladding 130 can also include one or more finishing coatings, which can be applied thereto at a construction site or at a factory or other prefabrication facility. Such finishing coating(s) can be applied after the 3D-printed material has been printed and customized to a desired final configuration and appearance.

Other components and features in a given hybrid building panel 110 can include one or more electrical chases 127 configured for the safe routing of electrical wiring, as well as flashing tape 128 applied at one or more strategic locations to ensure additional waterproofing properties of the overall hybrid building panel 110. For example, flashing tape 128 can be applied across the full length of both the top and bottom portions of hybrid building panel 110. In some embodiments, one or more lifting features 129 can be configured to facilitate transport of hybrid building panel 110 during hybrid building panel production, hybrid building panel installation to the entire building or a portion thereof, or both. Such lifting features 129 can include, for example, a negative-threaded lifting opening or point formed into a top portion of subframe 125, which can then be used to insert threaded external components or tools to facilitate the ready and quick transport of an entire hybrid building panel 110.

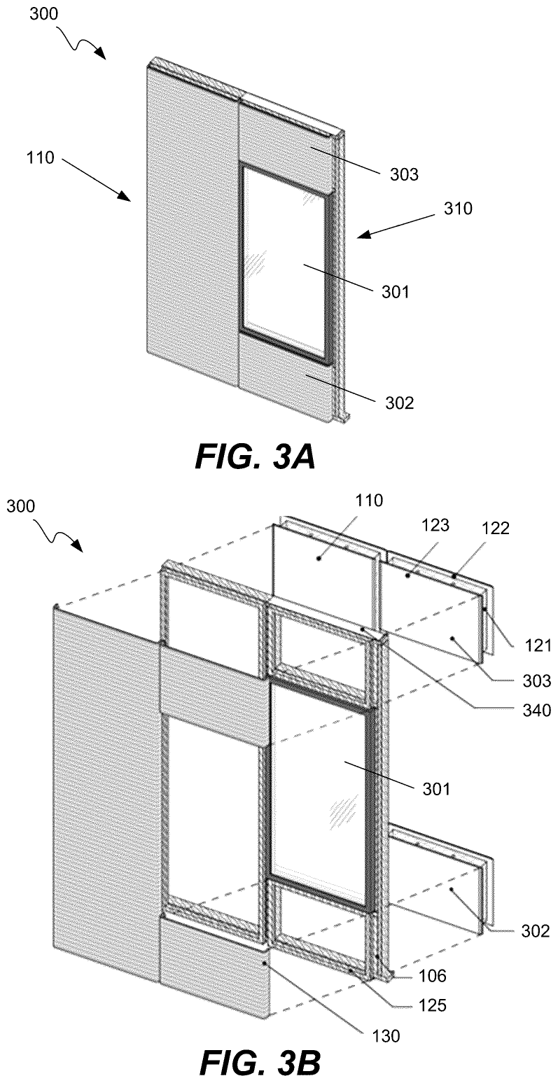

Turning next to FIGS. 3A and 3B, an example modular hybrid building panel system including a window assembly is illustrated in front perspective and exploded front perspective views respectively. As will be readily appreciated, the disclosed modular hybrid building panel systems and various components thereof can be designed and engineered to address diverse building construction requirements. For example, the disclosed hybrid building panels can range from 2 to 6 feet wide, from 1 to 12 feet tall, and from 4 to 12 inches thick, and a given modular hybrid building panel system can have multiple hybrid building panels of varying sizes and dimensions within these ranges, although other size and dimension ranges are also possible. In some arrangements, each hybrid building panel can weigh from 22 to 440 pounds, making it possible for two people to manually handle and install virtually all sizes of panels in varying different designs and situations. The varying hybrid building panel sizes can be standardized in some systems and building arrangements to simplify the design process for a building envelope of a rectangular or other desired shape. This versatility can enable a variety of different hybrid building panels to be used to form building envelopes for different common and customized wall arrangements, such as those including doors or windows, for example. This can include full length structural panels and also short panel segments, such as knee panels beneath windows or other openings, and header panels above windows, doors, or other openings.

Modular hybrid building panel system 300 can be similar to modular hybrid building panel system 100 above, albeit with modified hybrid building panels to accommodate a window assembly installed therewith. In a nonlimiting example shown for purposes of illustration, modular hybrid building panel system 300 can include a standard hybrid building panel 110 that is adjacent to and coupled side-by-side with a hybrid building panel and window assembly arrangement 310 that can have the same or similar height as the standard hybrid building panel to facilitate the ready integration of this system into a larger overall building envelope. Hybrid building panel and window assembly arrangement 310 can include a window assembly 301 arranged between knee panel 302 and header panel 303. Window assembly 301 can be any standard window and its associated frames, parts, or fasteners, and this window assembly can be considered as a separate component or as a part of modular hybrid building panel system 300.

Knee panel 302 can be located beneath window assembly 301 while header panel 303 can be located above the window assembly, and each of these panels can be a separate and relatively smaller hybrid building panel having the same basic components as hybrid building panel 110. For example, each of knee panel 302 and header panel 303 can have a customizable 3D-printed exterior cladding 130 coupled to an SIP with rigid insulation layer 121 sandwiched between inner stressed skin 122 and outer stressed skin 123, relief channels formed along its top, side, and bottom edges, and subframe 125 fitted within the relief channels. Although indicating at the outer stressed skins 123 in FIG. 3B, it will be understood that the designations for full length hybrid building panel 110, knee panel 302, and header panel 303 all reference the entire exploded panel for each respective hybrid building panel.

Like the standard full length hybrid building panel 110 adjacent thereto, the smaller knee panel 302 and header panel 303 can couple to other hybrid building panels and other separate building components by way of similar panel connectors and anchoring components. For example, knee panel 302 can couple to a separate building foundation (not shown) by way of a dimensional blocking component and suitable fasteners along its bottom edge and to hybrid building panel 110 and window assembly 301 by way of splines and suitable fasteners. Window assembly 301 can be installed using standard connectors or fasteners that are traditionally used in SIP construction, and such installation can be similar for doors or other building components or features located within a similar building panel assembly arrangement. In the event that window assembly 301 or any other opening within a similar building panel assembly arrangement is too large, such as wider than 6 feet, for example, then structural L-angles 340 can be used to provide enhanced structural integrity and reinforcement for the entire arrangement. This can involve using structural L-angles 340 above and/or below header panel 303, for example.

In some arrangements, a single spline or dimensional blocking component 106 can run along an entire side of hybrid building panel and window assembly arrangement 310, such that each of knee panel 302, window assembly 301, and header panel 303 can be coupled as a combined assembly to an adjacent hybrid building panel or other separate building component. Again, use of extended splines or dimensional blocking components that extend across multiple hybrid building panels and/or other assemblies can result in tying these panels and assemblies together and providing a ledge for increased overall structural integrity and strength. Although illustrated in the context of a window assembly, it will be understood that one or both of knee panel 302 and header panel 303 can also be used for other building openings, such as doors.

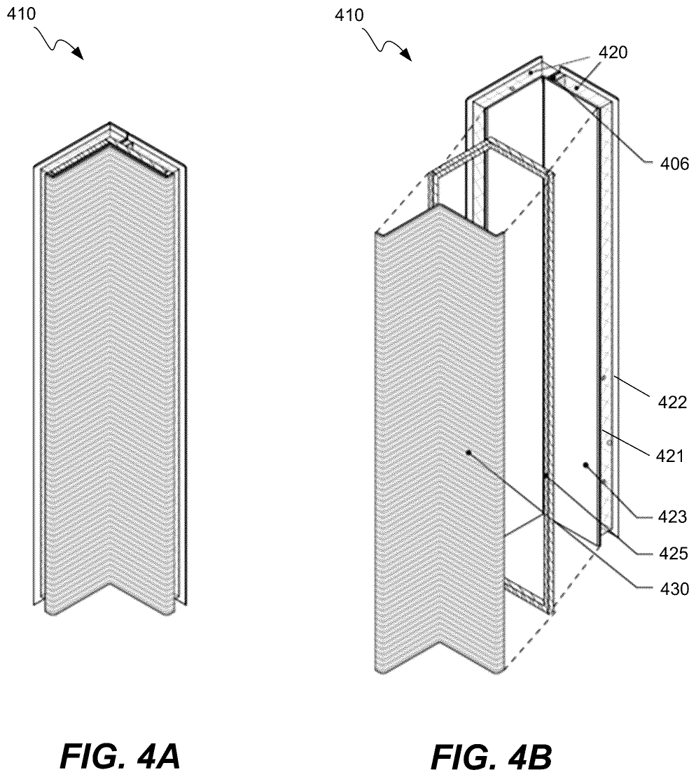

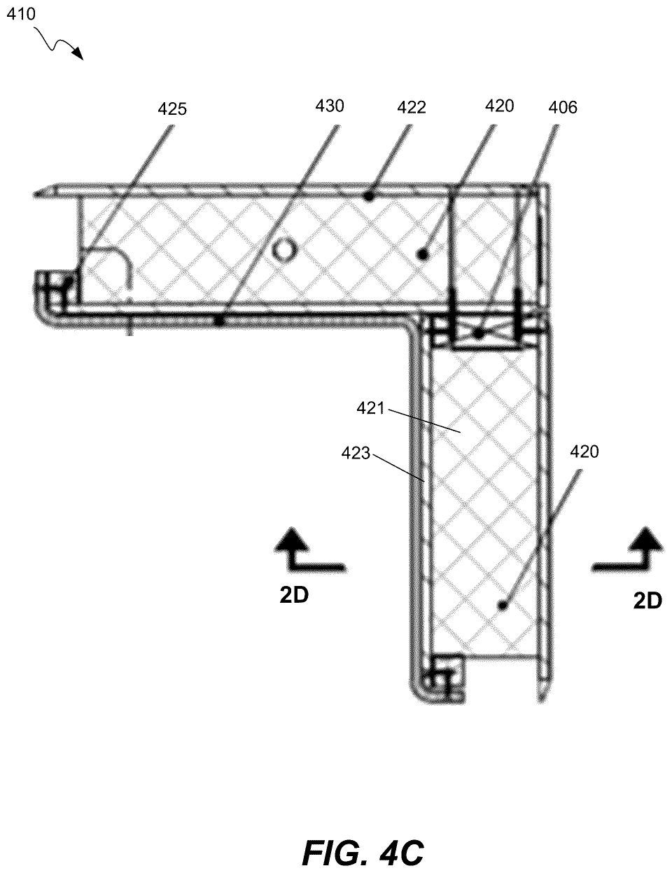

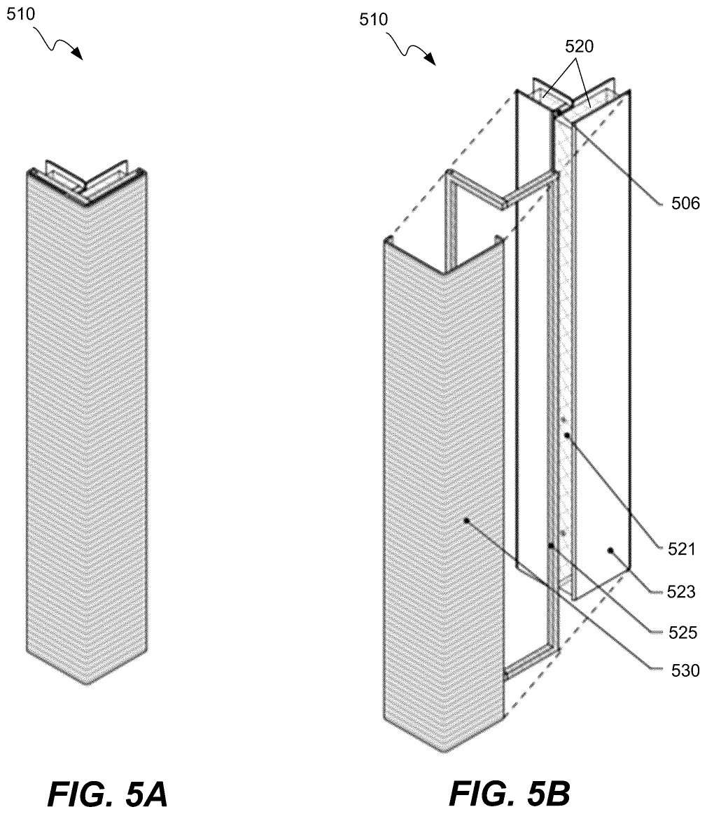

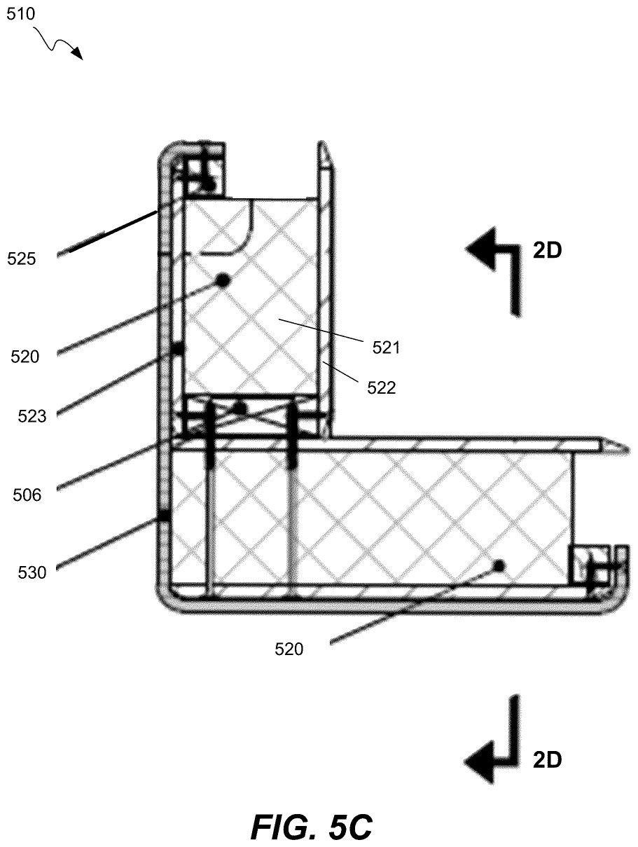

Moving now to FIGS. 4A-4C and 5A-5C, various considerations for corners in the disclosed modular hybrid panel building systems will now be provided. FIGS. 4A-4C depict an example hybrid building panel for an inside building corner in front perspective, exploded front perspective, and top cross-section views respectively, while FIGS. 5A-5C show an example hybrid building panel for an outside building corner in similar front perspective, exploded front perspective, and top cross-section views respectively. To further enhance structural versatility without sacrificing structural integrity or strength, the disclosed modular hybrid building panel systems are designed to be installed in both linear configurations or at angles to form corners of an overall building. The location of the customizable 3D-printed exterior cladding for each corner panel represents where the panel is seen from the exterior of a respective building.

As shown in FIGS. 4A-4C, inner corner hybrid building panel 410 can include two narrow SIPs 420 coupled together at a right angle to form a corner shape, with both of these SIPs being coupled with a customizable 3D-printed exterior cladding 430 that is formed into an inner corner shape from the perspective of outside of the building where panel 410 is located. As in the foregoing SIP arrangements, each narrow SIP 420 can include rigid insulation layer 421 sandwiched between inner stressed skin 422 and outer stressed skin 423, with the outer stressed skin being the skin closest to the customizable 3D-printed exterior cladding 430. One of the narrow SIPs 420 can have a spline or dimensional blocking component 406 inserted into and coupled to the narrow SIP within a relief channel formed along one side edge thereof, and the other narrow SIP 420 can be coupled along the face of its outer stressed skin 423 to this spline or dimensional blocking component 406 to form an SIP corner arrangement, as shown. Coupling the narrow SIPs 420 together can be accomplished using standard panel connectors as noted above to connect each narrow SIP to the spline or dimensional blocking component 406.

Inner corner subframe 425 can be similar to, can be formed from the same type of materials, and can be used for the same purposes and functions as subframe 125 above. Inner corner subframe 425 can form a more complex shape to match the shape of inner corner hybrid building panel 410, however, in that its top and bottom frame members can include two pieces coupled together at a right angle as shown. As in the case of subframe 125 above, inner corner subframe 425 can be positioned within relief channels of narrow SIPs 420 and coupled to the inner surfaces of outer stressed skins 423, as reflected in FIG. 4C. To ensure a seamless and aesthetically pleasing integration, customizable 3D-printed exterior cladding 430 can be specifically manufactured as a single integrally formed component to match precisely the overall corner shape of inner corner hybrid building panel 410. This can be done by 3D printing cladding 430 directly onto outer stressed skins 423 of narrow SIPs 420 or by 3D printing the cladding in isolation as a single unit and then coupling the cladding to the outer stressed skins.

As shown in FIGS. 5A-5C, outer corner hybrid building panel 510 can be substantially similar to inner corner hybrid building panel 410 in that it can include two narrow SIPs 520 coupled together at a right angle to form a corner shape, with each narrow SIP similarly including rigid insulation layer 521 sandwiched between inner stressed skin 522 and outer stressed skin 523. Both of narrow SIPs 520 can similarly be coupled with a customizable 3D-printed exterior cladding 530 that is formed into an outer corner shape from the perspective of outside of the building where outer corner hybrid building panel 510 is located. As shown in both of FIGS. 4C and 5C, a side cross-section taken along most of inner corner hybrid building panel 410 and outer corner hybrid building panel 510 can be represented by the side cross-section view of FIG. 2D above.

Like the foregoing corner embodiment, one of the narrow SIPs 520 can have a spline or dimensional blocking component 506 inserted into and coupled to the narrow SIP within a relief channel formed along one side edge thereof, and the other narrow SIP 520 can be coupled along the face of its outer stressed skin 523 to this spline or dimensional blocking component 506 to form an SIP corner arrangement, as shown. Coupling the narrow SIPs 520 together can be accomplished using standard panel connectors as noted above to connect each narrow SIP to the spline or dimensional blocking component 506. Outer corner subframe 525 can be similar to, can be formed from the same type of materials, and can be used for the same purposes and functions as subframes 125 and 425 above, and as such can be positioned within relief channels of narrow SIPs 520 and coupled to the inner surfaces of outer stressed skins 523, as reflected in FIG. 5C. To ensure a seamless and aesthetically pleasing integration, customizable 3D-printed exterior cladding 530 can similarly be specifically manufactured as a single integrally formed component to match precisely the overall corner shape of outer corner hybrid building panel 510, such as by 3D printing cladding 530 directly onto outer stressed skins 523 of narrow SIPs 520 or by 3D printing the cladding in isolation as a single unit and then coupling the cladding to the outer stressed skins.

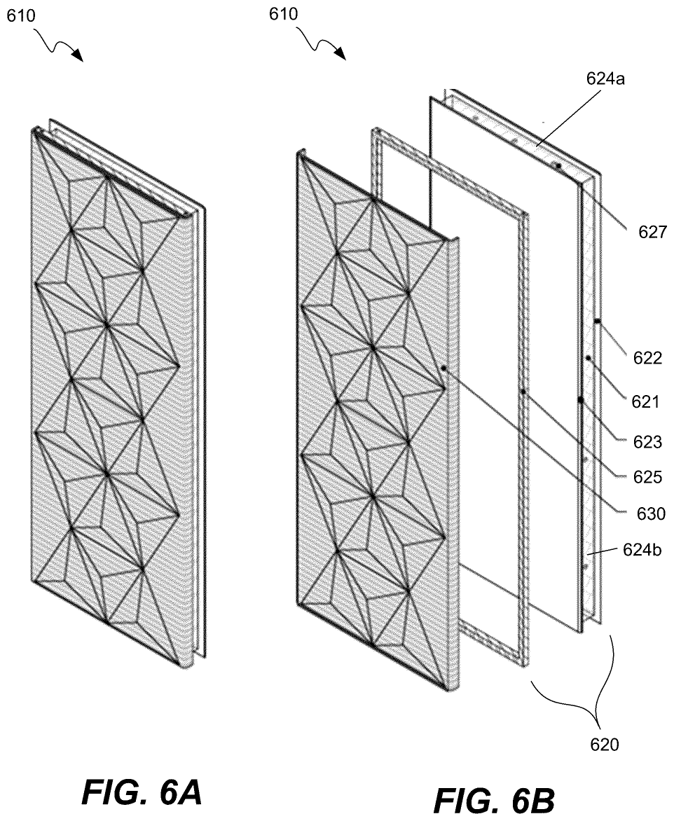

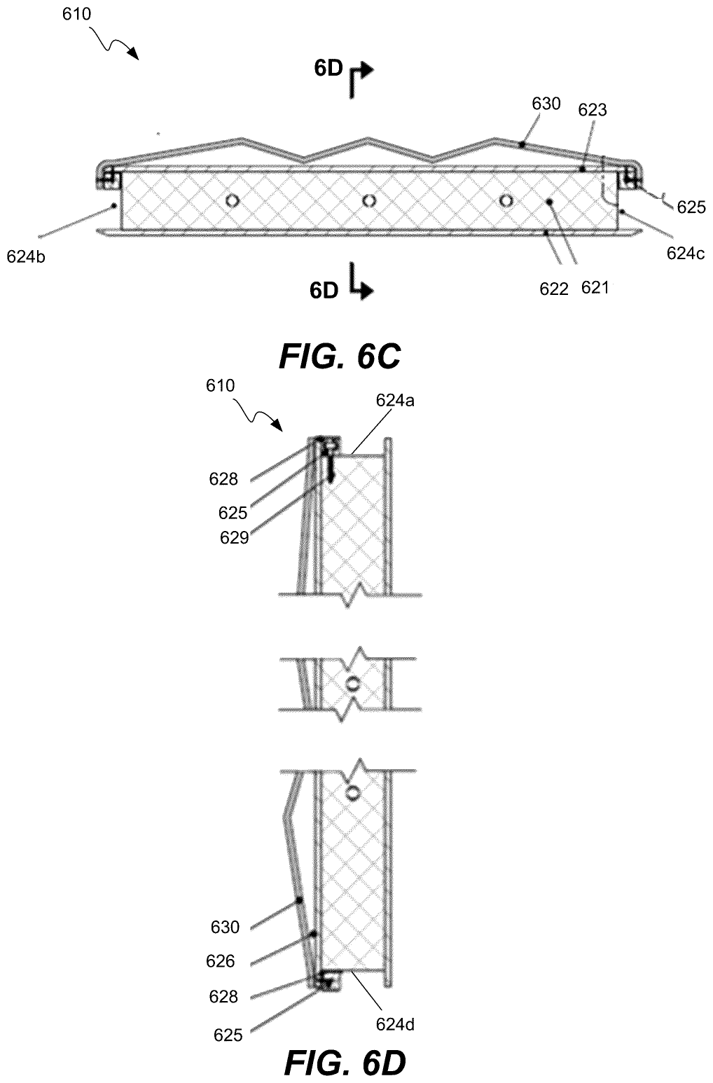

Transitioning now to FIGS. 6A-6D, an example hybrid building panel with decorative cladding is illustrated in front perspective, exploded front perspective, top cross-section, and side cross-section views respectively. As will be readily appreciated, decorative hybrid building panel 610 can be substantially similar to hybrid building panel 110 above except that it includes decorative cladding elements and features. As such, decorative hybrid building panel 610 can include an SIP 620 having rigid insulation layer 621 sandwiched between inner stressed skin 622 and outer stressed skin 623, subframe 625 positioned within each of relief channels 624a, 624b, 624c, 624d, adhesive 626, electrical chases 627, flashing tape 628, and lifting features 629, all of which can be identical or substantially similar to and similarly formed like counterpart components in hybrid building panel 110 above.

SIP 620 can be coupled with an exterior cladding, albeit a decorative customizable 3D-printed exterior cladding 630, which can include a variety of decorative elements and features that can be integrally formed during a 3D printing process. Use of decorative cladding 630 can enable extensive customization and add architectural complexity to an overall exterior building envelope to result in a distinctive façade appearance. Furthermore, the exterior region of decorative hybrid building panel 610 as defined by decorative customizable 3D-printed exterior cladding 630 can be modified to provide geometric flexibility, thus allowing for adaptations to various architectural styles and building shapes. Decorative customizable 3D-printed exterior cladding 630 can be adorned with diverse decorative 3D-printed elements and can be manufactured using advanced 3D printing technology from a weather-resistant, durable, polymer, composite material.

In various embodiments, decorative customizable 3D-printed exterior cladding 630 can be coupled to outer skin 623 of decorative hybrid building panel 610 by way of adhesive 626 and/or can be printed directly onto the outer skin and securely adhered to its outer facing. Decorative customizable 3D-printed exterior cladding 630 can also be coupled to subframe 625, and this can involve the use of one or more suitably sized and dimensioned screws, nails, bolts, rivets, staples, dowels, or any other suitable fastener, as well as any combination thereof. One specific nonlimiting example of such a coupling of decorative cladding 630 to subframe 625 using fasteners can be found at FIG. 9A below. As in foregoing embodiments, subframe 625 can be bonded using a structural sealant at the interfaces where the subframe meets rigid insulation layer 621 of SIP 620 and also where the subframe meets the inner surface of outer stressed skin 623, thus enhancing the structural integrity and stability of the overall assembly. Other coupling arrangements are also possible, as will be readily appreciated. In some embodiments, decorative customizable 3D-printed exterior cladding 630 can also include one or more finishing coatings, which can be applied thereto at a factory or other prefabrication facility.

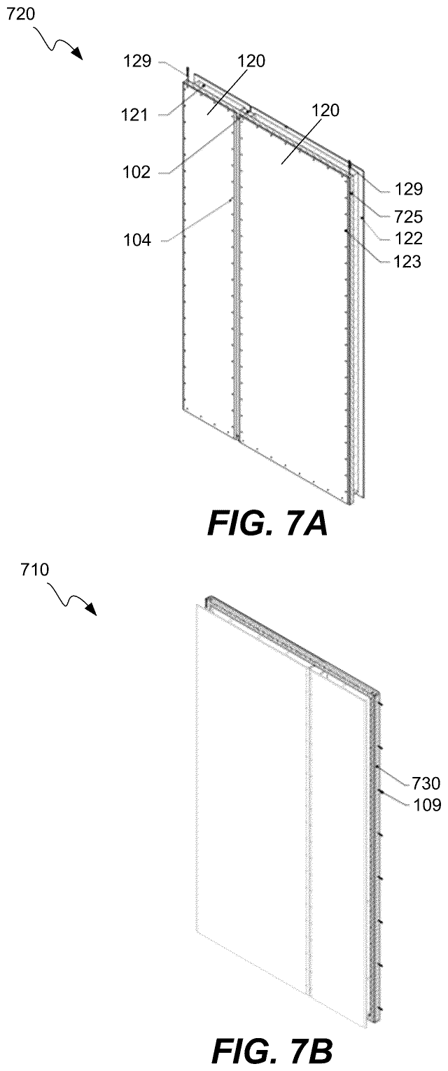

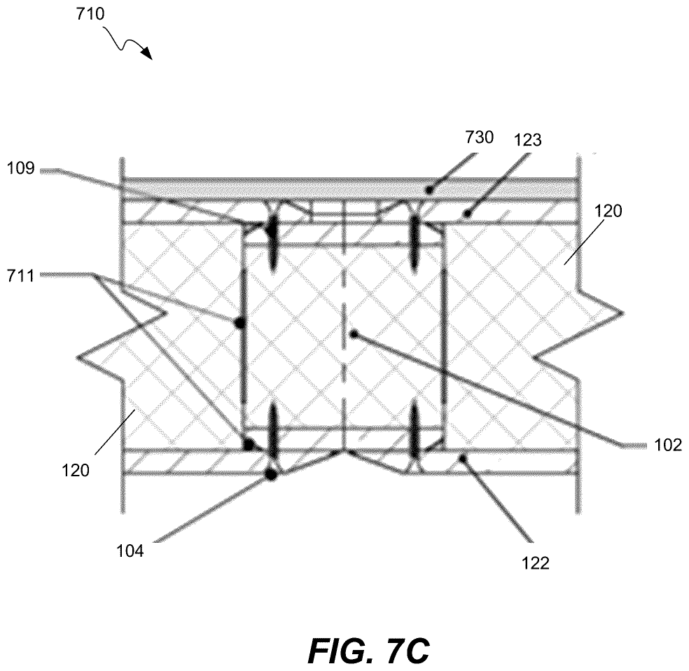

FIGS. 7A and 7B depict an example expanded hybrid building panel in front and rear perspective views, while FIG. 7C shows an example combining juncture of the expanded hybrid building panel in top cross-section view. For panels that are to be wider than a standard building panel width, such as 4 feet, for example, multiple separate panels can be combined to create a single larger panel. For example, multiple SIPs 120 can be coupled along their side edges to form laterally expanded SIP 720 as shown in FIG. 7A. A single integrally formed expanded customizable 3D-printed exterior cladding 730 can then be formed onto expanded SIP 720 to form expanded hybrid building panel 710, as shown in FIG. 7B.

As in the foregoing embodiments above, each SIP 120 can include a rigid insulation layer 121 sandwiched between inner and outer stressed skins 122, 123 or other suitable structural facing components. Each SIP 120 can also include similar edge relief channels, one or more lifting features 129, and various other components and features, as detailed above. To couple two SIPs 120 together along their side edges, a spline 102 can be inserted into a relief channel along the side edge of one SIP and the other SIP can then be placed atop the spline along its own side edge relief channel. In some arrangements, a structural sealant 711 can be placed along the spline and/or one or both side edge relief channels before coupling to provide structural seals at spline 102. These can be identical or similar to the structural sealants referenced above for similar usage with splines and dimensional blocking components. One or more panel fasteners 104 can be used to couple each SIP 120 to spline 102 to ensure robust structural integrity, and these can be the same or similar to the panel fasteners noted above.

Subframe 725 can be formed within the relief channels of the now expanded SIP 720 along the inner surfaces of outer stressed skins 123, and these can involve combined relief channels from each SIP 120 along the entire top and bottom edges of the expanded SIP. As in the foregoing embodiments, each element of subframe 725 can be coupled using a structural sealant and suitable fasteners through a respective outer stressed skin 123. Flashing tape can also be applied across the full lengths of the bottom and top portions of the panel, overlapping outer stressed skins 123 and extending over these skins and subframe 725 to enhance panel waterproofing. Expanded customizable 3D-printed exterior cladding 730 can be coupled onto expanded SIP 720 to form expanded hybrid building panel 710, as shown in FIGS. 7B and 7C. In particular, expanded customizable 3D-printed exterior cladding 730 can be formed over both SIPs 720 after they are coupled together using spline 102, structural sealants 711, and cladding fasteners 109, such that a single monolithic exterior cladding covers the full exterior face of hybrid building panel, as reflected in the cross-section view of FIG. 7C.

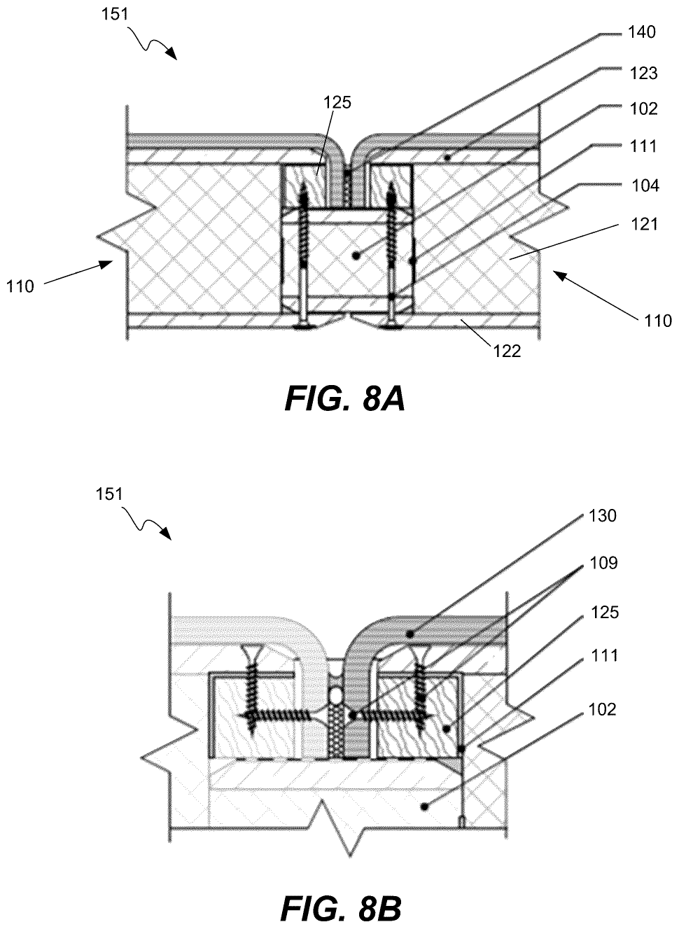

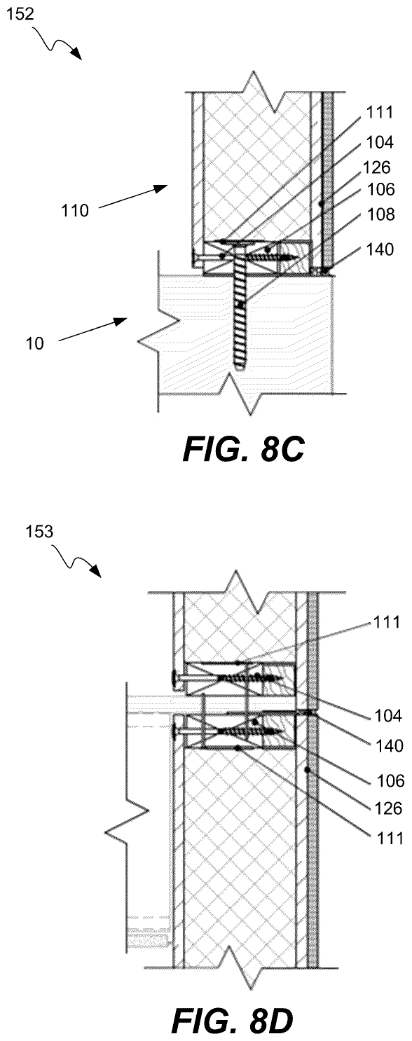

FIG. 8A illustrates in top cross-section view an example side coupling juncture for side-by-side coupled hybrid building panels, while FIG. 8B shows a close-up front region of the side coupling juncture. Side coupling juncture 151 can be a juncture between side-by-side fully formed and independent separate hybrid building panels 110, such as that which is illustrated for modular hybrid building panel system 100 in FIG. 1 above, for example. Again, each separate hybrid building panel 110 can include its own customizable 3D-printed exterior cladding 130 coupled to an SIP having a rigid insulation layer 121, inner stressed skin 122, outer stressed skin 123, relief channels, subframe 125, and other items as set forth in detail above.

Coupling two hybrid building panels 110 together at side coupling juncture 151 can involve the use of a spline 102 that can be inserted into side relief channels of both panels. A structural sealant 111 can be placed between spline 102 and each hybrid building panel 110 to ensure a tight seal between items, such as along the rigid insulation layer edge of each panel. One or more panel fasteners 104 can be used to fasten hybrid building panels 110 to spline 102, such as by inserting the panel fasteners into the inner stressed skin of each panel, through the spline, and into the subframe of each panel, as reflected in FIG. 8A. One or more cladding fasteners 109 can be used to couple customizable 3D-printed exterior cladding 130 to its respective SIP on each hybrid building panel, as reflected in FIG. 8B. As noted above, one or more adhesives can also be used for such coupling purposes. One or more joint seals 140 can be applied at various joints, junctures, and surfaces of the combined system to facilitate improved waterproofing of the overall modular hybrid building panel system.

FIG. 8C illustrates in side cross-section view an example bottom coupling juncture for coupling a hybrid building panel to a building foundation or floor assembly. Bottom coupling juncture 152 can illustrate one example way of coupling a hybrid building panel 110 along its bottom edge to a building foundation 10 or floor assembly. As noted above, this can involve the use of a dimensional blocking component 106 and one or more anchor fasteners 108 to couple the dimensional blocking to foundation 10. Hybrid building panel 110 can then be coupled along its bottom edge to dimensional blocking component 106.

This can involve placing a bottom relief channel along the panel bottom edge atop dimensional blocking component 106 and inserting one or more panel fasteners 104 into hybrid building panel 110 and the dimensional blocking component. For example, panel fasteners can be inserted at an inner surface of an inner stretched skin, through the dimensional blocking component, and into a subframe of the hybrid building panel. A structural sealant 111 can be applied within the bottom relief channel before inserting dimensional blocking component 106 therein. As also shown an adhesive 126 can be used to couple a customizable 3D-printed exterior cladding to an outer stressed skin of the panel, and one or more joint seals 140 can again be placed at one or more strategic locations on hybrid building panel 110, such as between the exterior cladding and building foundation 10.

FIG. 8D illustrates in top cross-section view an example vertical coupling juncture for multiple hybrid building panels. Vertical coupling juncture 153 can reflect coupling of multiple hybrid building panels, and can include at least one dimensional blocking component 106 inserted into relief channels along the edges of multiple hybrid building panels, as well as structural sealants 111, panel fasteners 104, and one or more joint seals 140 between panels. As noted above, dimensional blocking can serve as a ledger, tying multiple panels together and further enhancing the structural stability of an overall modular hybrid building panel system.

Turning next to FIG. 9, a flowchart of an example method of prefabricating a hybrid building panel is provided. Method 900 can involve the production or prefabrication of hybrid building panels, such as those that can be used to create an integrated building envelope system or other modular hybrid building panel system at a building construction site. Various steps of method 900 can be performed in different orders and/or simultaneously, such as during prefabrication or manufacturing of hybrid building panels at a factory or other production facility. Furthermore, some steps may be omitted, other steps may be added, and/or all steps may be repeated as desired in varying orders until a given hybrid building panel is prefabricated or otherwise created. After a start step 902, a first process step 904 can involve selecting a SIP, which can be a standard SIP having a rigid insulation layer between stressed skins.

At a following process step 906 the selected SIP can be cut or otherwise reduced to a specific size, such as a size commensurate with a final hybrid building panel to be prefabricated. At the next process step 908 the inner and outer stressed skins of the selected SIP can be trimmed to specific geometric configurations, such as overall sizes and shapes commensurate with the final hybrid building panel to be prefabricated.

At subsequent process step 910 the rigid insulation can be removed from the top, side, and bottom edges of the SIP to form relief channels along all SIP edges. This can be done by cutting the rigid insulation away, for example, although other ways of removing rigid insulation can also be used. Relief channels can be formed along each edge by portions of the stressed skins then extending past the rigid insulation layer on both sides of the rigid insulation layer.

At following decision step 912, an inquiry can be made as to whether additional SIPs are to be combined to form an extended or thicker SIP. If not, then the method can continue to decision step 914 where a further inquiry can be made. If so, then the method can revert to process step 904 and some or all of steps 904 through 910 can be repeated to create another customized SIP cut to size with specifically sized skins and with relief channels formed along all edges of the SIP. Multiple customized SIPs can be formed where, for example, an extended SIP is desired in the event that an SIP wider than a standard four feet is desired.

At the next decision step 914, an inquiry can be made as to whether multiple SIPs need to be coupled together or otherwise combined. If not, then the method can proceed to process step 922. If so, however, then the method can divert to process step 916 where a structural sealant can be applied to side edge relief channels in each SIP that is to be coupled to another SIP. As noted above, structural sealant can generally be applied to any relief channel where a coupling is to be made with another SIP or any other separate building component.

At the next process step 918, a spline can be inserted into side edge relief channels where SIPs are to be coupled to each other. This can involve putting the spline into a side edge relief channel of one SIP and then placing another SIP onto the spline along its own side edge relief channel, as will be readily appreciated. Process step 920 can involve coupling the affected SIPs to the spline inserted into their respective relief channels, which can be accomplished by using fasteners through each SIP and into the spline, as noted above. Steps 916 through 920 can be repeated where more than two SIPs are to be coupled together to form an extended SIP.

After a single SIP is formed at step 910 or an extended SIP is formed with all coupled SIPs at step 920, then process step 922 can involve forming or creating a subframe within all of the relief channels along the edges of the single SIP or extended SIP, as noted and illustrated in the various embodiments above. As noted above, creating a subframe in the relief channels can include using a structural sealant to affix the subframe to inner surfaces of the outer stretched skins, and can also include fastening the subframe by way of one or more panel connectors or other suitable fasteners.

The next process step 924 can then involve forming one or more lifting features in the subframe, such as negative threaded lifting holes formed along a top member of the subframe, for example. Process step 926 can involve applying flashing tape along the top and bottom portions of the entire panel, overlapping the outer stressed skin and extending over the skin and the subframe to enhance overall waterproofing of the panel.

At subsequent process step 928, a customizable 3D-printed exterior cladding can then be formed onto or otherwise coupled to an exterior surface of the outer stressed skin or skins. This can involve printing the cladding directly onto the exterior surfaces, laminating the cladding, and/or coupling the cladding with one or more suitable fasteners, as shown above. Process step 930 can then involve machining or otherwise fashioning the customizable 3D-printed exterior cladding to desired dimensions and geometric configurations (i.e., customizing the cladding). This can be done precisely to form an exterior cladding as desired. A final process step can involve applying a protective and uniform coating to the exterior surface of the 3D-printed exterior cladding to enhance both the visual appeal and durability of the cladding. The method can then end at end step 934.

It will be understood that not all steps will be needed for some processes, such that various condensed versions of method 900 can be used. Furthermore, the order of steps can be altered as may be practical or optimal for a given method, and one or more steps can be performed simultaneously as may be practical and desired. For example, a given summary method may involve performing only steps 904, 910, 922, and 928 to create a rudimentary hybrid building panel as described and illustrated above. Additional steps or functions can also be performed as may be necessary or desired for a given panel.

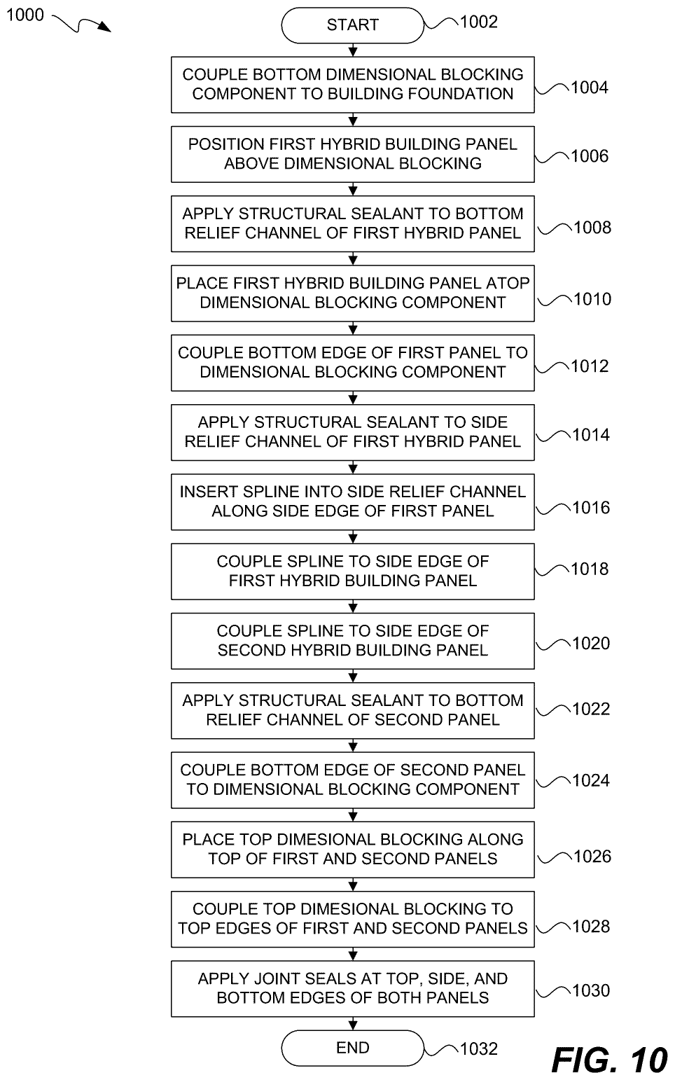

Lastly, FIG. 10 illustrates a flowchart of an example method of assembling a modular hybrid building panel system to a building. Method 1000 can be performed in conjunction with method 900 set forth above, such as by using prefabricated hybrid building panels formed by the above method. As in the above method 900, various steps of method 1000 can be performed in different orders and/or simultaneously, such as during an ongoing overall building construction process. Furthermore, some steps may be omitted, other steps may be added, and/or all steps may be repeated as desired in varying orders until an entire panel system is assembled to a building or building envelope. Various aspects of this method 1000 of assembling a modular hybrid building panel system to a building can be apparent with respect to FIG. 1 and its detailed description set forth above. Method 1000 can involve selecting and working with at least two hybrid building panels, and these can be any of the foregoing illustrated and detailed hybrid building panels and/or any other hybrid building panels that may be extrapolated or customized according to the foregoing principles. As such, each hybrid building panel used can include at least a modified SIP with relief channels along all edges coupled to a customizable 3D-printed exterior cladding.

After a start step 1002, a first process step 1004 can involve coupling a bottom dimensional blocking component to a building foundation or floor assembly. Dimensional blocking can serve as a foundational base for the subsequent installation of various hybrid building panels and associated components, thus enhancing the structural integrity of the entire modular hybrid building system. As noted above, the dimensional blocking component can be formed of wood, steel, composite lumber, or any other suitable material, and can be coupled by way of one or more anchoring components, which can be suitably sized and dimensioned screws, nails, bolts, rivets, staples, dowels, or any other suitable fasteners.

At a subsequent process step 1006, a first hybrid building panel can be positioned in a vertical orientation above and parallel to the dimensional blocking component. The next process step 1008 can involve applying a structural sealant to a bottom relief channel formed along a bottom edge of the first hybrid building panel. Process step 1010 can then involve placing the first hybrid building panel atop the dimensional blocking component such that the dimensional blocking inserts into the bottom relief channel. Next, process step 1012 can include coupling the bottom edge of the first hybrid building panel to the dimensional blocking component. This can involve inserting one or more fasteners or other suitable panel connectors through the interior surface of the inner stressed skin along the bottom of the first hybrid building panel and into the dimensional blocking component, which can enhance the structural bond.

At subsequent process step 1014, a structural sealant can be applied to a side relief channel formed along a side edge of the first hybrid building panel. Process step 1016 can then involve inserting a spline into the side relief channel with the structural sealant applied thereto. Again, the spline can be formed from suitably sized and dimensioned composite lumber, lumber, steel, sheet goods, fiberglass structural shapes, or a thin SIP having a rigid insulation layer between two stressed skins. Next, process step 1018 can include coupling the side edge of the first hybrid building panel to the spline. This can involve inserting one or more fasteners or other suitable panel connectors through the interior surface of the inner stressed skin along the side of the hybrid building panel and into the spline to enhance the structural bond therebetween. The panel connectors can also be inserted into the subframe of the first hybrid building panel.

A following process step 1020 can include coupling the spline to the side edge of a second hybrid building panel. As in the foregoing couplings, this can involve applying a structural sealant to a side relief channel along a side edge of the second hybrid building panel and then placing that side relief channel over the spline. One or more panel connectors can then similarly be used to fasten the second hybrid building panel to the spline. This can include inserting the panel connectors through a stressed skin, spline, and subframe of the panel.

At the next process step 1022, a structural sealant can be applied to a bottom relief channel along a bottom edge of the second hybrid building panel. Process step 1024 can then involve coupling the bottom edge of the second hybrid building panel to the bottom dimensional blocking component, which can similarly include placing the bottom relief channel of the second panel atop the bottom dimensional blocking component and applying suitable panel connectors or other fasteners through the second panel and bottom dimensional blocking component.

Subsequent process step 1026 can then involve placing a top dimensional blocking component into top relief channels along the top edges of both of the first and second hybrid building panels. This can involve inserting a structural sealant into the top relief channels before placing the top dimensional blocking component therein. Process step 1028 can then involve coupling the top dimensional blocking component to the top edges of the first and second hybrid building panels, such as by applying panel connectors or other suitable fasteners through the top inner facing of both hybrid building panels and into the top dimensional blocking component. As noted above, this dimensional blocking component can serve as a ledger by tying the panels together and further enhancing structural stability of the overall system.

At the next process step 1030, joint seals can be applied at various strategic locations on the modular hybrid building panel system. This can include applying joint seals at the top, side, and bottom edges of both of the first and second hybrid building panels, as well as at the spline, top and bottom dimensional blocking components, and any other suitable location where a joint seal can provide added protection to the overall system. Various steps can be repeated in the event that further hybrid building panels are also to be installed to the modular hybrid building panel system, as will be readily appreciated. The method can then end at end step 1032.

It will be understood that not all steps will be needed for some processes, such that various condensed versions of method 1000 can be used. Furthermore, the order of steps can be altered as may be practical or optimal for a given system installation or construction process. For example, all structural sealant steps can be performed prior to any installation of a relief channel onto a dimensional blocking component or spline. Additional steps or functions can also be performed as may be necessary. Such additional steps can include after installation customization of and/or coating application to the 3D-printed exterior cladding on any hybrid building panel for example, among other possible process steps.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A modular hybrid building panel system configured to form an envelope for an entire building or a portion thereof, the system comprising:
a plurality of hybrid building panels, wherein each hybrid building panel includes at least a structural insulated panel (“SIP”) coupled with a customizable 3D-printed exterior cladding;
a plurality of panel connectors coupled to the plurality of hybrid building panels and configured to couple the plurality of hybrid building panels to each other horizontally, vertically, or both; and
a plurality of anchoring components coupled to the plurality of hybrid building panels and configured to couple the plurality of hybrid building panels to one or more separate building components.

2. The system of claim 1, wherein each of at least a portion of the plurality of hybrid building panels includes:
an SIP having a rigid insulation layer between inner and outer stressed skins, as well as relief channels formed along the panel sides, top, and bottom,
a customizable 3D-printed exterior cladding,
a subframe coupling the exterior cladding to the SIP,
flashing tape configured to prevent water penetration, and
one or more lifting features configured to facilitate transport of the hybrid building panel during hybrid building panel production, hybrid building panel installation to the entire building or a portion thereof, or both.

3. The system of claim 1, wherein at least a portion of the plurality of hybrid building panels ranges from 2 to 6 feet wide, from 1 to 12 feet tall, and from 4 to 12 inches thick.

4. The system of claim 1, wherein at least a portion of the plurality of hybrid building panels provides resistance to racking, axial and transverse loading, fireproofing, insulation, and exterior cladding capabilities to the entire building or a portion thereof.

5. The system of claim 1, wherein at least a portion of the plurality of hybrid building panels are installed in a linear configuration or at an angle forming corners of the entire building or a portion thereof.

6. The system of claim 1, wherein at least a portion of the plurality of hybrid building panels include integrated electrical chases.

7. The system of claim 1, wherein at least a portion of the plurality of panel connectors include one or more splines that include composite lumber, lumber, steel, sheet goods, fiberglass structural shapes, or a thin SIP having a rigid insulation layer between two stressed skins.

8. The system of claim 1, wherein at least a portion of the plurality of anchoring components include dimensional blocking formed of wood, steel, or composite lumber.

9. The system of claim 1, wherein at least a portion of the customizable 3D-printed exterior cladding is fabricated via 3D printing layer extrusion from a weather-resistant, durable, polymer composite material.

10. The system of claim 1, wherein at least a portion of the customizable 3D-printed exterior cladding includes an outer surface that is planar and flat, that is configured to be modified to provide geometric flexibility, or both.

11. The system of claim 1, wherein at least a portion of the customizable 3D-printed exterior cladding is affixed to an SIP outer stressed skin with one or more adhesives, screws, nails, bolts, rivets, staples, dowels, or any combination thereof.

12. The system of claim 1, wherein at least a portion of the customizable 3D-printed exterior cladding is printed directly to and is securely adhered to an SIP outer stressed skin.

13. The system of claim 1, wherein at least a portion of the customizable 3D-printed exterior cladding includes one or more finishing coatings.

14. The system of claim 1, wherein at least one of the plurality of hybrid building panels forms a header panel located above a window, door, or other building opening.

15. The system of claim 14, wherein the header panel is structurally reinforced with structural L-angles above and below the header panel.

16. A method of assembling a modular hybrid building panel system to a building, the method comprising:
coupling a bottom dimensional blocking component to a foundation or a floor assembly of the building;
placing a first hybrid building panel atop the bottom dimensional blocking component, wherein the first hybrid building panel includes a first structural insulated panel (“SIP”) coupled with a first customizable 3D-printed exterior cladding;
coupling a bottom edge of the first hybrid building panel to the bottom dimensional blocking component by extending one or more fasteners through an interior surface of the first hybrid building panel, through the bottom dimensional blocking component, and into a first subframe of the first SIP;
coupling a spline to a side edge of the first hybrid building panel by extending one or more fasteners through the interior surface of the first hybrid building panel, through the spline, and into the first subframe of the first SIP;
coupling the spline to a side edge of a second hybrid building panel by extending one or more fasteners through an interior surface of the second hybrid building panel, through the spline, and into a second subframe of a second SIP, wherein the second hybrid building panel includes the second SIP coupled with a second customizable 3D-printed exterior cladding;
coupling a bottom edge of the second hybrid building panel to the bottom dimensional blocking component by extending one or more fasteners through the interior surface of the second hybrid building panel, through the bottom dimensional blocking component, and into the second subframe of the second SIP;
placing a top dimensional blocking component along top edges of the first and second hybrid building panels; and
coupling the top dimensional blocking component to the top edges of the first and second hybrid building panels by extending multiple fasteners through the first and second interior surfaces of the first and second hybrid building panels, through the top dimensional blocking component, and into the first and second subframes, wherein the top dimensional blocking component then functions as a ledger for the first and second hybrid building panels.

17. The method of claim 16, further comprising the steps of:
positioning the first hybrid building panel above the bottom dimensional blocking component,
applying structural sealant to a bottom relief channel along the bottom edge of the first hybrid building panel;
applying structural sealant to a side relief channel along the side edge of the first hybrid building panel;
inserting the spline into a side relief channel along the side edge of the first hybrid building panel;
applying structural sealant to a bottom relief channel along the bottom edge and a side relief channel along the side edge of a second hybrid building panel; and
applying a joint seal at the top edges, side edges, bottom edges, and exterior surfaces of both of the first and second hybrid building panels.

18. A method of prefabricating a hybrid building panel, the method comprising:
selecting a first structural insulated panel (“SIP”), wherein the first SIP includes a rigid insulation layer between inner and outer stressed skins;
removing portions of the rigid insulation layer to form relief channels along top, bottom, and side edges of the first SIP;
creating a subframe within the relief channels such that the subframe is affixed to an inner surface of the outer stressed skin; and
coupling a 3D-printed exterior cladding to an exterior surface of the outer stretched skin using an adhesive, a plurality of mechanical fasteners, or both.

19. The method of claim 18, further comprising the steps of:
cutting the first SIP to a specified size;
trimming edges of the inner and outer stressed skins according to specific geometric configurations;
forming one or more lifting features along a top portion of the subframe, wherein the one or more lifting features are configured to facilitate transport of the hybrid building panel during hybrid building panel production, installation to a building, or both;
applying flashing tape across the top and bottom edges of the first SIP such that a portion of the flashing tape extends over the outer stressed skin and the subframe;
machining the 3D-printed exterior cladding according to customized dimensions and configurations; and
coating the 3D-printed exterior cladding to provide a uniform and protective finish.

20. The method of claim 18, further comprising the steps of:
selecting a second SIP, wherein the second SIP includes a second rigid insulation layer between second inner and outer stressed skins;
removing portions of the second rigid insulation layer to form relief channels along top, bottom, and side edges of the second SIP;
applying structural sealant to side relief channels along similar side edges of the first and second SIPs;
inserting a spline into both of the side relief channels having structural sealant applied thereto; and
coupling the first SIP and the second SIP to the spline by extending multiple fasteners through each SIP and into the spline.
